(19) United States
(12) Patent Application Publication
(10) Pub. No.: US 2018/0139048 A1
(43) Pub. Date: May 17, 2018

(54) MESSAGE AUTHENTICATOR GENERATING APPARATUS

(71) Applicant: Mitsubishi Electric Corporation, Tokyo (JP)

(72) Inventor: Yusuke NAITO, Tokyo (JP)

(73) Assignee: Mitsubishi Electric Corporation, Tokyo (JP)

(21) Appl. No.: 15/578,606

(22) PCT Filed: Jul. 15, 2015
(86) PCT No.: PCT/JP2015/070287

§ 371 Date: Nov. 30, 2017

(51) Int. Cl. H04L 9/32; H04L 9/06

(52) U.S. Cl. CPC H04L 9/3226; H04L 9/0631; H04L 9/0643

(57) ABSTRACT

A message authenticator generating apparatus, taking as input a key K and a message M, generates an i-times-e-bit value E, and divides the value E at every e bit to generate values M[1], . . . , M[i]. During this, the message authenticator generating apparatus generates the value E such that a value M[1] and a value M[i] out of the values M[1], . . . , M[i] include at least one of bits of the key K. The message authenticator generating apparatus, where a value S[0] is an arbitrary value, for each integer j of j=1, . . . , i in an ascending order, calculates a value R[j] by a function g[j] taking as input a value S[j−1] and a value M[j], and substitutes the calculated value R[j] by a substitution function P[j] to calculate a value S[j]. The message authenticator generating apparatus generates an authenticator T for the message M with using a value S[i].

### TECHNICAL FIELD

The present invention relates to a technology of generating an authenticator for a message safely and efficiently with using substitution.

### BACKGROUND ART

With a message authentication algorithm, when messages are exchanged between two parties, a recipient can confirm whether or not the transmitted message has been tampered with.

When tampering detection is to be checked using the message authentication algorithm, a key K is shared by the two parties in advance. The sender of the message generates an authenticator T for a message M from the message M and the key K, and sends the message M and the authenticator T to the recipient. The recipient of the message generates an authenticator T′ from the received message M and the key K. If the authenticator T and the authenticator T′ match, the recipient judges that the message M has not been tampered with. If the authenticator T and the authenticator T′ do not match, the recipient judges that the message has been tampered with.

The security of the message authentication algorithm is expressed by the indistinguishability with respect to a random function.

Assume that a message authentication algorithm F satisfies the indistinguishability. This means that, considering a distinguisher D who interacts with either the real world or the ideal world, which world the distinguisher D interacts with cannot be distinguished.

In the real world, the key K is randomly chosen, and the distinguisher D can choose the message M and obtain a message authenticator of F(K, M). In the ideal world, for a random function R, the distinguisher D can choose the message M and obtain an output value of R(M). Here, the distinguisher D can choose the message M as often as he or she wishes, and can obtain an output value of F(K, M) or R(M) corresponding to the chosen message M.

More precisely, consider a distinguisher D who outputs a 1-bit value. The indistinguishability of the message authentication algorithm F is evaluated by the difference between the probability that the distinguisher D outputs 1 in the real world and the probability that the distinguisher D outputs 1 in the ideal world. The distinguisher D can obtain a plurality of outputs of the message authentication algorithm F in the real world, and can obtain a plurality of outputs of the random function R in the ideal world. Assuming that the total bit count of the message M at this time is σ, the above difference of the probabilities is evaluated by a probability p(σ) using σ. The value of the bit count a such that the probability p(σ)=1 is called a distinction calculation amount. The value of the bit count σ is a calculation amount necessary for distinction. The larger the value of the bit count σ, the higher the security.

Note that log₂ σ is called a security bit of indistinguishability. For example, in the case of σ=2¹²⁸, the security bit is log₂ 2¹²⁸=128 bits.

If a function F satisfies the security of indistinguishability, the function F can be used as the message authentication algorithm and also as a pseudo-random number generation algorithm. Therefore, the function F can be used as a function used in Key Derivation Function, stream cipher, and so on.

Non-Patent Literature 5 describes a message authentication algorithm which uses a sponge-structure hash function employing a substitution function, the hash function being described in Non-Patent Literature 7.

Non-patent Literature 8 describes a message authentication algorithm which is improved over the message authentication algorithm described in Non-Patent Literature 5 in terms of the speed.

As a hash function H in Non-Patent Literature 9, a hash function described in Non-Patent Literature 7, which is a sponge-structure hash function employing a substitution function, is used to configure a message authentication algorithm.

### CITATION LIST

### Patent Literature

Patent Literature 1: JP 2009-129391 A

Patent Literature 2: JP 2009-5163 A

### Non-Patent Literature

Non-Patent Literature 1: Mihir Bellare, Ran Canetti, and Hugo Krawczyk, “Keying Hash Functions for Message Authentication”, CRYPTO 1996, p1-15

Non-Patent Literature 2: Mihir Bellare, “New Proofs for NMAC and HMAC: Security without Collision-Resistance”, CRYPTO 2006, p602-619

Non-Patent Literature 3: Ralph C. Merkle, “One Way Hash Functions and DES”, CRYPTO 1989, p428-446

Non-Patent Literature 4: Ivan Damgard, “A Design Principle for Hash Functions”, CRYPTO 1989, p416-427

Non-Patent Literature 5: G. Bertoni, J. Daemen, M. Peeters, and G. V. Assche, “On the security of the keyed sponge construction”, Symmetric Key Encryption Workshop (SKEW)

Non-Patent Literature 6: Elena Andreeva, Joan Daemen, Bart Mennink, and Gilles Van Assche, “Security of Keyed Sponge Constructions Using a Modular Proof Approach”, Fast Software Encryption 2015 (FSE 2015)

Non-Patent Literature 7: G. Bertoni, J. Daemen, and M. Peeters, “Sponge functions”, Ecrypt Hash Workshop 2007

Non-Patent Literature 8: G. Bertoni, J. Daemen, and M. Peeters, “Permutation-based encryption, authentication and authenticated encryption”, Directions in Authenticated Ciphers 2012

Non-Patent Literature 9: “The Keyed-Hash Message Authentication Code (HMAC)”, FIPS PUB 198-1

Non-Patent Literature 10: Guido Bertoni, Joan Daemen, Michael Peeters, and Gilles Van Assche, “On the Indifferentiability of the Sponge Construction”, EUROCRYPT 2008, p181-197

### SUMMARY OF INVENTION

### Technical Problem

Non-Patent Literature 6 indicates that with the message authentication algorithm described in Non-Patent Literatures 5 and 8, the security bit is min{k, c/2, b/2} if the substitution function is random substitution. Non-Patent literature 10 indicates that with the message authentication algorithm using the hash function described in Non-Patent Literature 7 as the hash function H in Non-Patent Literature 9, if the substitution function is random substitution, the security bit is min{c/2, b/2, n/2, k}.

Here, k is the bit count of the key K, b is the bit count of input/output of the substitution function, c is the bit count of capacity where b=c+r, r is the bit count of the rate, and n is the bit count of the authenticator.

The present invention has as its object to at least, with respect to a message authentication algorithm using a substitution function, improve the security or reduce the calculation amount.

### Solution to Problem

A message authenticator generating apparatus according to the present invention includes:
an input value generation unit to, taking as input a key K and a message M, generate an i-times-e-bit value E, and divide the value E at every e bit to generate values M[1], M[i], the input value generation unit generating the value E such that a value M[1] and a value M[i] out of the values M[1], M[i] include at least one of bits of the key K;
a function calculation unit to, where a value S[0] is an arbitrary value, for each integer j of j=1, i in an ascending order, calculate a value R[j] by a function g[j] taking as input a value S[j−1] and a value M[j], and substitute the calculated value R[j] by a substitution function P[j] to calculate a value S[j]; and
an authenticator generation unit to generate an authenticator T for the message M with using a value S[i] calculated by the function calculation unit.

### Advantageous Effects of Invention

According to the present invention, a message authentication algorithm whose security bit is min{c, b/2, k}, if the substitution function P[j] is random substitution, can be implemented.

### BRIEF DESCRIPTION OF DRAWINGS

FIG. 1 is a configuration diagram of a message authenticator generating apparatus 100 according to Embodiment 1.

FIG. 2 is a flowchart illustrating an operation of the message authenticator generating apparatus 100 according to Embodiment 1.

FIG. 3 is an explanatory diagram of a message authentication algorithm according to Embodiment 1.

FIG. 4 is an explanatory diagram of a message authentication algorithm according to Embodiment 1.

FIG. 5 is a configuration diagram of a message authenticator generating apparatus 100 according to Embodiment 2.

FIG. 6 is a flowchart illustrating an operation of the message authenticator generating apparatus 100 according to Embodiment 2.

FIG. 7 is an explanatory diagram of a message authentication algorithm according to Embodiment 2.

FIG. 8 is an explanatory diagram of a message authentication algorithm according to Embodiment 2.

FIG. 9 is an explanatory diagram of a message authentication algorithm according to Embodiment 2.

FIG. 10 is an explanatory diagram of a message authentication algorithm according to Embodiment 2.

FIG. 11 is a diagram illustrating a hardware configuration example of a case where the function of the message authenticator generating apparatus 100 is implemented by software.

FIG. 12 is a diagram illustrating a hardware configuration example of a case where the function of the message authenticator generating apparatus 100 is implemented by hardware.

### DESCRIPTION OF EMBODIMENTS

Embodiment 1

***Explanation of Configuration***

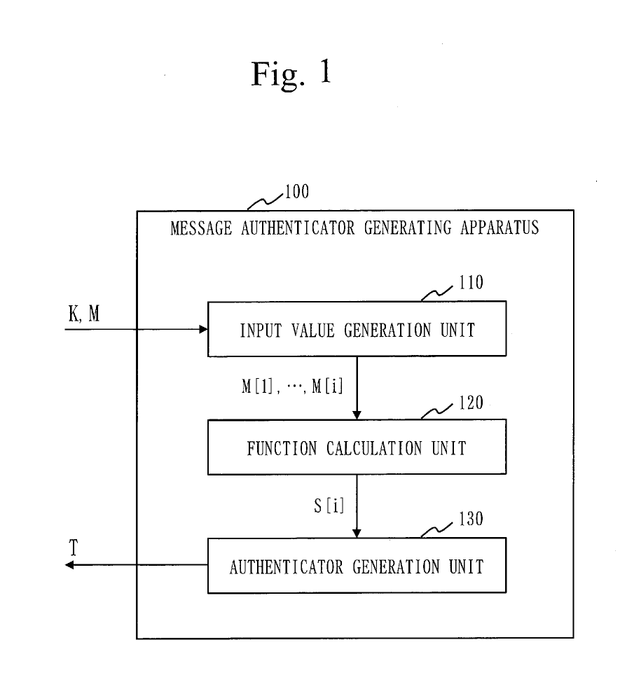

With reference to FIG. 1, a configuration of a message authenticator generating apparatus 100 according to Embodiment 1 will be described.

The message authenticator generating apparatus 100 generates an n-bit authenticator T for a k-bit key K and a message M. The message M is data to be transmitted. The key K is a secret key shared in advance with a transmission destination of the message M. Note that k and n are integers equal to or greater than 1

The message authenticator generating apparatus 100 includes an input value generation unit 110, a function calculation unit 120, and an authenticator generation unit 130.

The input value generation unit 110, taking as input the key K and the message M, generates i pieces of e-bit values M[1], M[i] where i and e are integers equal to or greater than 1.

The function calculation unit 120, taking as input the values M[1], M[i] generated by the input value generation unit 110, calculates a value S[i] being a hash value by a sponge-structure hash function H which uses a substitution function.

The authenticator generation unit 130 generates the authenticator T for the message M with using the value S[i] calculated by the function calculation unit 120.

***Explanation of Operation***

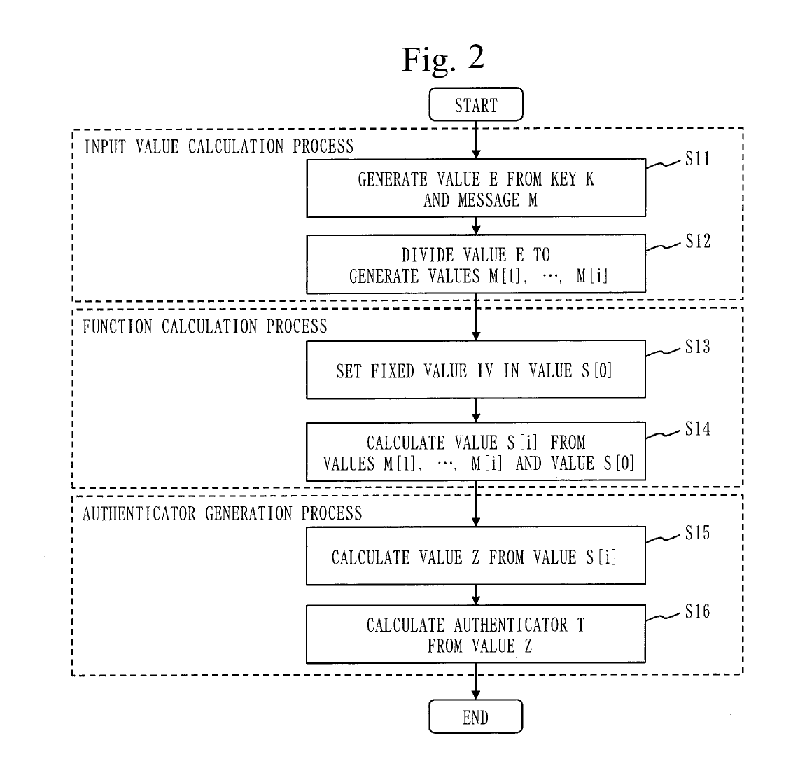

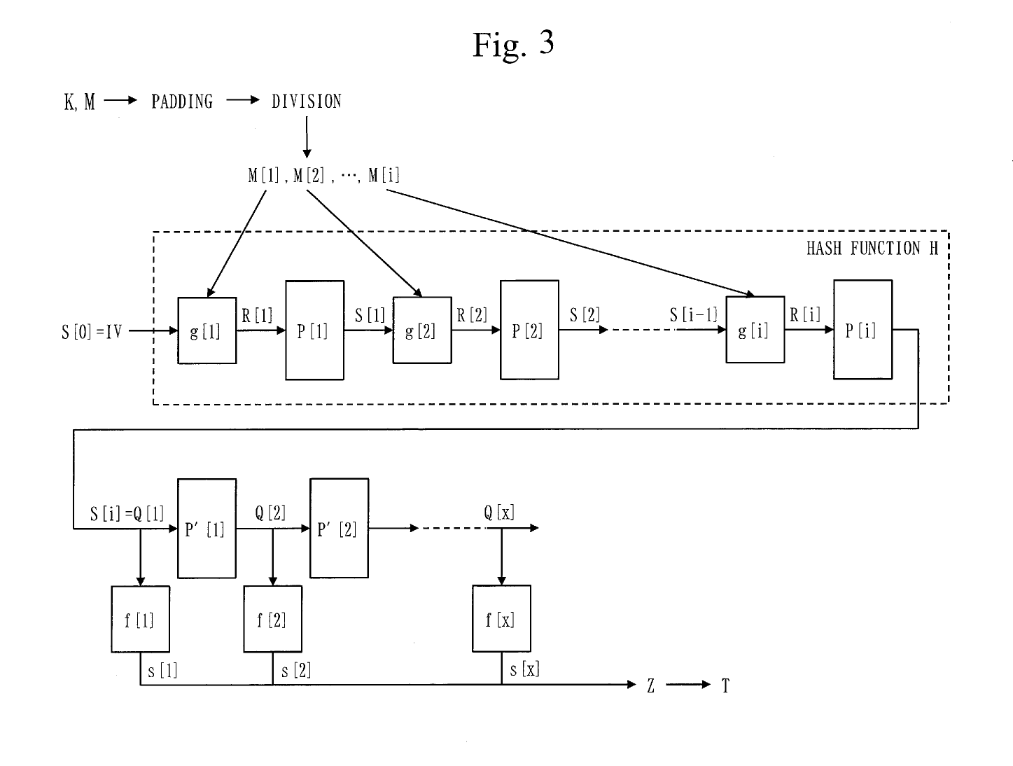

With reference to FIGS. 2 and 3, an operation of the message authenticator generating apparatus 100 according to Embodiment 1 will be described. The operation of the message authenticator generating apparatus 100 according to Embodiment 1 corresponds to a message authenticator generating method according to Embodiment 1. The operation of the message authenticator generating apparatus 100 according to Embodiment 1 also corresponds to processing of a message authenticator generating program according to Embodiment 1.

Note that 0≤d<b and e=b−d.

In a padding process of S11, the input value generation unit 110, taking as input the key K and the message M to a padding function, generates an i-times-e-bit value E. Particularly, the input value generation unit 110 generates the value E such that a value M[1] and a value M[i] out of the values M[1], M[i] to be described later include at least one of bits of the key K.

The padding function is a function that adjoins a bit string to an input value.

In a division process of S12, the input value generation unit 110 divides the value E at every e bit from its head to generate the values M[1], M[i].

In a value-S[0]-setting process of S13, the function calculation unit 120 sets a b-bit fixed value IV in a value S[0].

In a hash value calculation process of S14, for each integer j of j=1, i in an ascending order, the function calculation unit 120 calculates R[j]=g[j](S[j−1], M[j]) and S[j]=P[j](R[j]). That is, the function calculation unit 120, for each integer j of j=1, i in the ascending order, calculates a value R[j] by a function g[j] taking as input the value S[j−1] and the value M[j] which is generated by the input value generation unit 110, and substitutes the calculated value R[j] by a substitution function P[j] to calculate the value S[j].

Each function g[j] is a function which, taking as input two values, one of which has b bit and the other has e bit, outputs a b-bit value. Each function g[j] is a b-bit substitution function if the e-bit value is fixed. Each function g[j] may be identical or different. Each substitution function P[j] is a b-bit substitution function. Each substitution function P[j] may be identical or different.

In a value Z calculation process of S15, the authenticator generation unit 130 treats as a value Z, a value s[1] calculated by a compression function f[1] taking as input the value S[i]. Then, the authenticator generation unit 130, where a value Q[1] is the value S[i], in an ascending order starting with j=1 until the value Z has n bit or more, adjoins to the value Z, a value s[j+1] calculated by a compression function f[j+1] taking as input a value Q[j+1] obtained by substituting a value Q[j] by a substitution function P′[j].

Each compression function f[j] is a function that compresses a b-bit value into an r-bit value. Each compression function f[j] may be identical or different. Each substitution function P′[j] is a b-bit substitution function. Each substitution function P′[j] may be identical or different.

In an authenticator extraction process of S16, when the value Z has n bit or more, the authenticator generation unit 130 treats n bit out of the value Z as the authenticator T.

The processes of S11 to S12 constitute an input value generation process. The processes of S13 to S14 constitute a function calculation process. The processes of S15 to S16 constitute an authenticator generation process.

*** Effect of Embodiment 1 ***

The message authenticator generating apparatus 100 according to Embodiment 1 can implement a message authentication algorithm that uses a substitution function. When the substitution function P[j] is random substitution, the implemented message authentication algorithm has a security bit of min{c, b/2, k}.

The message authentication algorithms described in Non-Patent Literatures 5 and 8 each have a security bit of min{k, c/2, b/2} where c/2<b/2. The value of k corresponds to the length of the key. Hence, the longer the key, the larger the value of k. To increase the length of the security bit, the value of c/2 need be increased.

The message authentication algorithm implemented by the message authenticator generating apparatus 100 according to Embodiment 1 has a security bit of min {c, b/2, k}. Therefore, the length of the security bit can be increased easily as compared to the message authentication algorithms described in Non-Patent Literatures 5 and 8.

***Other Configuration***

In S11, the input value generation unit 110 may generate the value E in the following manner.

The input value generation unit 110 adjoins the message M to the end of the key K to generate a value A. The input value generation unit 110 adjoins a value X to the end of the value A to generate a multiple-of-e-bit value C. The input value generation unit 110 adjoins the key K to the end of the value C to generate a value D.

The input value generation unit 110 adjoins a value Y to the end of the value D to generate the value E having i-times-e-bit. That is, E=K∥M∥X∥K∥Y where “∥” is a symbol representing concatenation.

Practical examples of the value X and the value Y are each a bit string in which the first bit and the last bit are 1 and the remaining bits are 0. That is, X=1∥0 . . . 0∥1 and Y=1∥0 . . . 0∥1. The value Y is the shortest bit string with which the value E has multiple-of-e bit. When the value D has multiple-of-e bit, the value Y is a 0-bit bit string.

Each function g[j] may be a function that calculates an exclusive OR. That is, in S14, the function calculation unit 120 may, for each integer j of j=1, i in an ascending order, calculate R[j]=S[j−1] xor (M[j]∥0^{d}) and S[j]=P[j](R[j]).

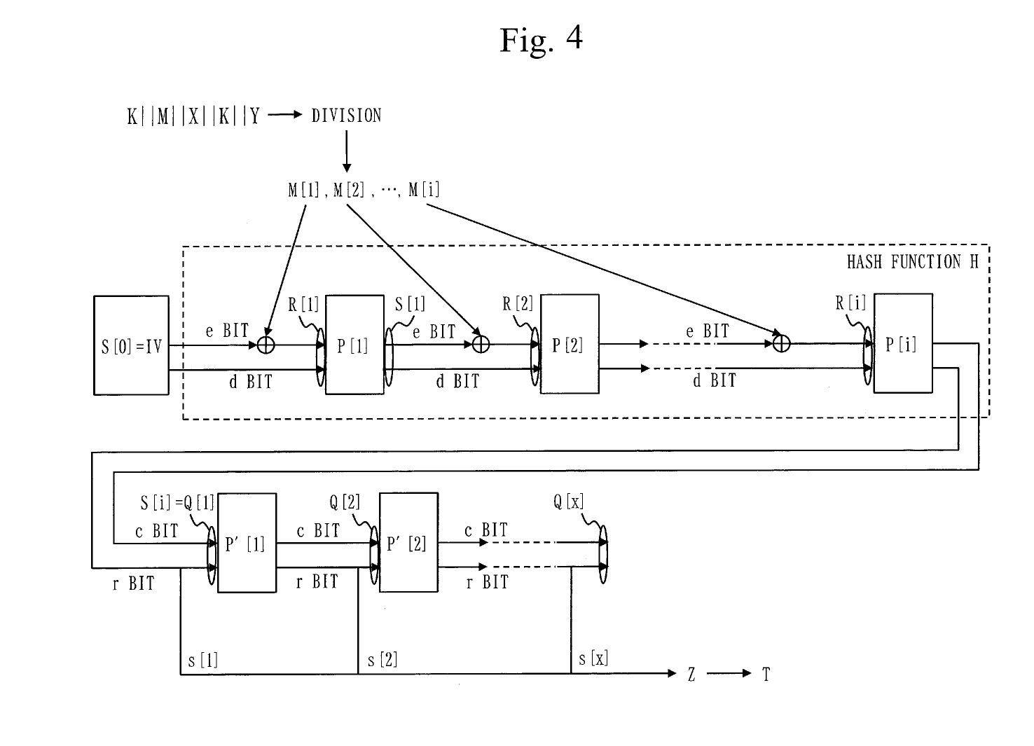

Calculation of the exclusive OR of an input value and 0 yields the input value as it is. Hence, as illustrated in FIG. 4, the value R[j] may be a value obtained by combining an exclusive OR of M[j] and e bit out of S[j−1], with the remaining d bit out of S[j−1]. That is, calculation of an exclusive OR of 0^{d} and d bit out of S[j−1] may be omitted.

Note that M[j]∥0^{d} is employed. That is, d-bit 0 is adjoined to the end of the value M[j]. However, the position where 0 is adjoined need not be the end of the value M[j]. More specifically, d-bit 0 may be adjoined to the beginning of the value M[j]. That is, 0^{d}∥M[j] may be employed.

The compression function f[j] may be a function that extracts r bit from the input value. That is, in S15, the authenticator generation unit 130, where a value Z is r bit out of the value S[i] and where a value Q[1] is the value S[i], in an ascending order starting with j=1 until the value Z has n bit or more, may adjoin to the value Z, r bit out of the value Q[j+1] obtained by substituting the value Q[j] by a substitution function P′[j].

That is, the message authentication algorithm illustrated in FIG. 3 may be configured as illustrated in FIG. 4. In FIG. 4, the calculation of the value E is configured as E=K∥M∥X∥K∥Y. The calculation of the value R[j] is configured as R[j]=S[j−1] xor (M[j]∥0^{d}). The compression function f[j] is configured as a function that extracts r bit from an input value.

Embodiment 2

***Explanation of Configuration***

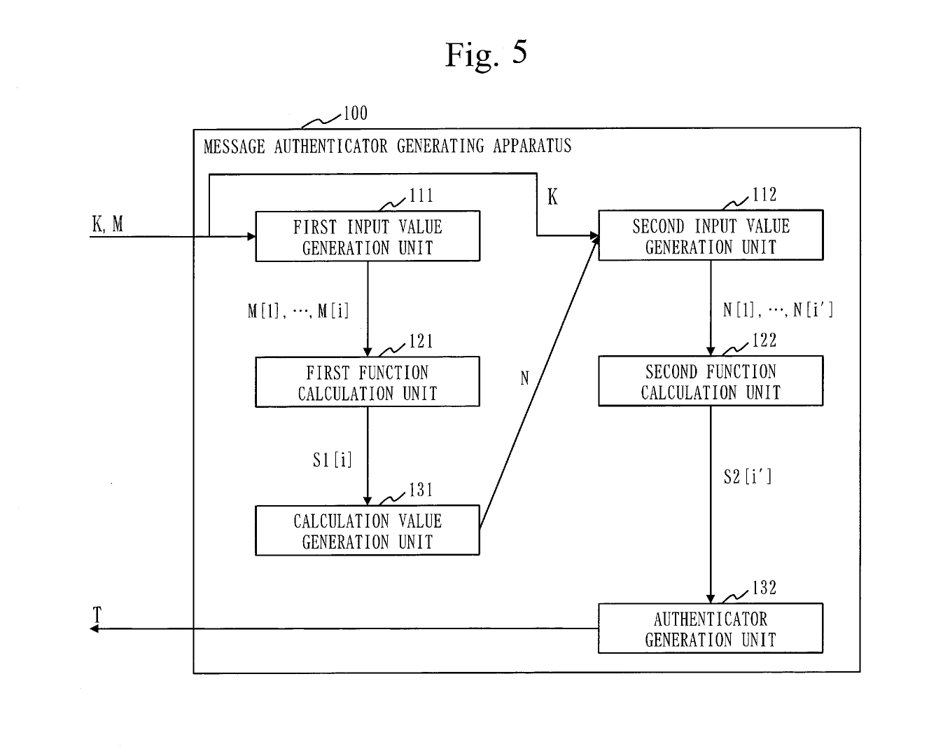

With reference to FIG. 5, a configuration of a message authenticator generating apparatus 100 according to Embodiment 2 will be described.

The message authenticator generating apparatus 100 generates an n-bit authenticator T for a k-bit key K and a message M. The message M is data to be transmitted. The key K is a secret key shared in advance with a transmission destination of the message M. Note that k and n are integers equal to or greater than 1.

The message authenticator generating apparatus 100 includes a first input value generation unit 111, a second input value generation unit 112, a first function calculation unit 121, a second function calculation unit 122, a calculation value generation unit 131, and an authenticator generation unit 132.

The first input value generation unit 111, taking as input the key K and the message M, generates e1-bit values M[1], . . . , M[i] where e1 is an integer equal to or greater than 1.

The second input value generation unit 112, taking as input the key K and a value N which is calculated by the calculation value generation unit 131 to be described later, generates e3-bit values N[1], N[i′] where i′ is an integer equal to or greater than 1 and e3 is an integer equal to or greater than 1.

The first function calculation unit 121, taking as input the values M[1], . . . , M[i] generated by the first input value generation unit 111, calculates a value S1[i] being a hash value by a sponge-structure hash function H which uses a substitution function.

The second function calculation unit 122, taking as input the values N[1], . . . , N[i′] generated by the second input value generation unit 112, calculates a value S2[i′] being a hash value by a sponge-structure hash function H′ which uses a substitution function.

The calculation value generation unit 131 generates the value N with using the value S1[i] calculated by the first function calculation unit 121.

The authenticator generation unit 132 generates the authenticator T for the message M with using the value S2[i′] calculated by the second function calculation unit 122.

***Explanation of Operation***

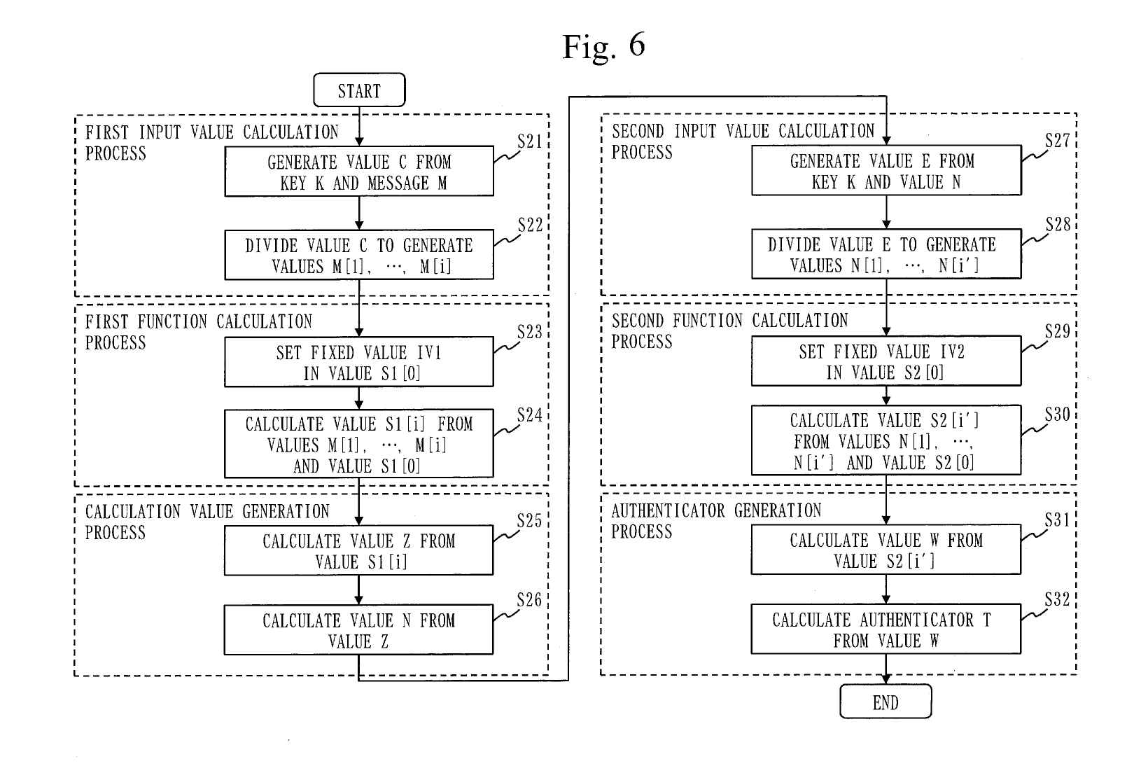

With reference to FIGS. 6 to 8, an operation of the message authenticator generating apparatus 100 according to Embodiment 2 will be described.

The operation of the message authenticator generating apparatus 100 according to Embodiment 2 corresponds to a message authenticator generating method according to Embodiment 2. The operation of the message authenticator generating apparatus 100 according to Embodiment 2 also corresponds to processing of a message authenticator generating program according to Embodiment 2.

Note that 0≤d1, d2, d3<b, e1=b−d1, e2=b−d2, and e3=b−d3 where e2 is an integer equal to or greater than 1 and v is an integer equal to or greater than 1.

In a first padding process of S21, the first input value generation unit 111, taking as input the key K and the message M to a padding function, generates an i-times-e1-bit value C. Particularly, the first input value generation unit 111 generates the value C such that a value M[1] out of the values M[1], M[i] to be described later includes at least one of bits of the key K.

The padding function is a function that adjoins a bit string to an input value.

In a first division process of S22, the first input value generation unit 111 divides the value C at every e1 bit from its head to generate the values M[1], . . . , M[i].

In a value-S1[0]-setting process of S23, the first function calculation unit 121 sets a b-bit fixed value IV1 in a value S1[0].

In a first hash value calculation process of S24, for each integer j of j=1, i in an ascending order, the first function calculation unit 121 calculates R[j]=g1[j] (S1[j−-1], M[i]) and S1[j]=P1[j](R1[j]). That is, for each integer j of j=1, i in the ascending order, the first function calculation unit 121 calculates a value R1[j] by a function g1[j] taking as input the value S1[j−1] and the value M[j] which is generated by the first input value generation unit 111, and substitutes the calculated value R1[j] by a substitution function P1[j] to calculate the value S1[j].

Each function g1[j] is a function which, taking as input two values, one of which has b bit and the other has e1bit, outputs a b-bit value. Each function g1[j] is a b-bit substitution function if the e1-bit value is fixed. Each function g1[j] may be identical or different. Each substitution function P1[j] is a b-bit substitution function. Each substitution function P1[j] may be identical or different.

In a value Z calculation process of S25, the calculation value generation unit 131 treats as a value Z, a value s1[1] calculated by a compression function f1 [1] taking as input the value S1[i]. The calculation value generation unit 131, where a value Q1[1] is the value S1[i], in an ascending order starting with j=1 until the value Z has v bit or more, adjoins to the value Z, a value s1[j+1] calculated by a compression function f1[j+1] taking as input a value Q1[j+1] obtained by substituting a value Q1[j] by a substitution function P1′[j].

Each compression function f1[j] is a function that compresses a b-bit value into an e2-bit value. Each compression function f1[j] may be identical or different. Each substitution function P1′[j] is a b-bit substitution function. Each substitution function P1′[j] may be identical or different.

In a calculation value extraction process of S26, when the value Z has v bit or more, the calculation value generation unit 131 treats v bit out of the value Z as the value N.

In a second padding process of S27, the second input value generation unit 112, taking as input the key K and the value N to a padding function, generates an i′-times-e3-bit value E. In particular, the second input value generation unit 112 generates the value E such that a value N[1] out of the values N[1], N[i] includes at least one of bits of the key K.

In a second division process of S28, the second input value generation unit 112 divides the value E at every e3 bit from its head to generate the values N[1], N[′i].

In a value-S2[0]-setting process of S29, the second function calculation unit 122 sets a b-bit fixed value IV2 in a value S2[0].

In a second hash value calculation process of S30, the second function calculation unit 122, for each integer j of j=1, i′ in an ascending order, calculates R2[j]=g2[j] (S2[−1], N[j]) and S2[j]=P2[j] (R2[j]). That is, the second function calculation unit 122, for each integer j of j=1, i′ in the ascending order, calculates a value R2[j] by a function g2[j] taking as input the value S2[j−1] and the value N[j] which is generated by the second input value generation unit 112, and substitutes the calculated value R2[j] by a substitution function P2[j] to calculate the value S2[j].

Each function g2[j] is a function which, taking as input two values, one of which has b bit and the other has e3 bit, outputs a b-bit value. Each function g2[j] is a b-bit substitution function if the e3-bit value is fixed. Each function g2[j] may be identical or different. Each substitution function P2[j] is a b-bit substitution function. Each substitution function P2[j] may be identical or different.

In a value W calculation process of S31, the authenticator generation unit 132 treats as a value W, a value s2[1] calculated by a compression function f2[1] taking as input the value S2[i′]. Then, the authenticator generation unit 132, where a value Q2[1] is the value S2[i′], in an ascending order starting with j=1 until the value W has n bit or more, adjoins to the value W, a value s2[j+1] calculated by a compression function f2[j+1] taking as input a value Q2[j+1] obtained by substituting a value Q2[j] by a substitution function P2′[j].

Each compression function f2[j] is a function that compresses a b-bit value into an r-bit value. Each compression function f2[j] may be identical or different. Each substitution function P2′[j] is a b-bit substitution function. Each substitution function P2′[j] may be identical or different.

In an authenticator extraction process of S32, when the value W has n bit or more, the authenticator generation unit 132 treats n bit out of the value W as the authenticator T.

The processes of S21 to S22 constitute a first input value generation process.

The processes of S23 to S24 constitute a first function calculation process. The processes of S25 to S26 constitute a calculation value generation process. The processes of S27 to S28 constitute a second input value generation process. The processes of S29 to S30 constitute a second function calculation process. The processes of S31 to S32 constitute an authenticator generation process.

***Effect of Embodiment 2***

The message authenticator generating apparatus 100 according to Embodiment 2 can implement a message authentication algorithm that uses a substitution function. When the substitution function P1[j] and the substitution function P2[j] are random substitution, the implemented message authentication algorithm has a security bit of min{c, b/2, v/2, k}.

***Other Configuration***

In S21, the first input value generation unit 111 may generate the value C in the following manner. The first input value generation unit 111 calculates, as a value K1, an exclusive OR of a key K and a k-bit fixed value ipad. The first input value generation unit 111 adjoins a message M to the end of the value K1 to generate a value A. The first input value generation unit 111 adjoins a value X to the end of the value A to generate an i-times-e1-bit value C. That is, C=K∥M∥X.

A practical example of the value X is a bit string in which the first bit and the last bit are 1 and the remaining bits are 0. That is, X=1∥0 . . . 0∥1. The value X is the shortest bit string with which the value C has multiple-of-e1 bit. When the value A has multiple-of-e1 bit, the value X is a 0-bit bit string.

Each function g[j] may be a function that calculates an exclusive OR. That is, in S24, the first function calculation unit 121 may, for each integer j of j=1, i in an ascending order, calculate R1[j]=S1[j−1] xor (M[j]∥0^{d1}) and S1[j]=P1[j] (R1[j]).

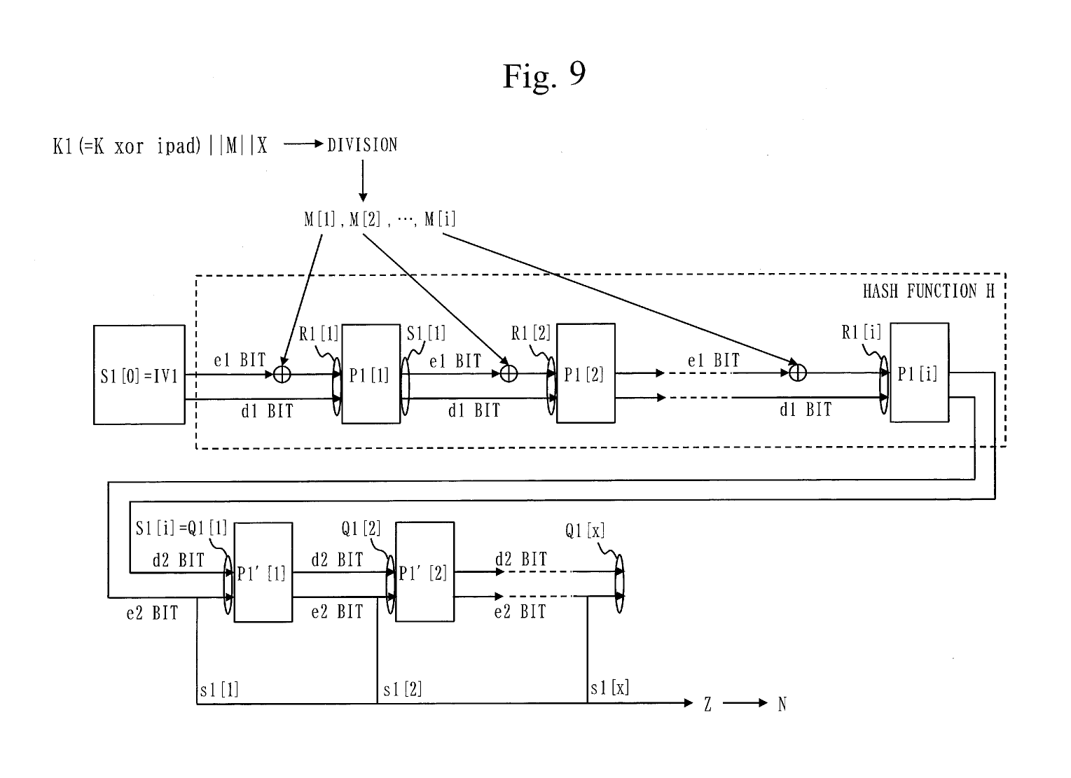

Calculation of the exclusive OR of an input value and 0 yields the input value as it is. Hence, as illustrated in FIG. 9, the value R[j] may be a value obtained by combining an exclusive OR of M[j] and e1 bit out of S1[j−1], with the remaining d1 bit out of S1[j−1]. That is, calculation of an exclusive OR of 0^{d1} and d1 bit out of S1[j−1] may be omitted.

Note that M[j]0^{d1} is employed. That is, d1-bit 0 is adjoined to the end of the value M[j]. However, the position where 0 is adjoined to need not be the end of the value M[j]. More specifically, dl-bit 0 may be adjoined to the beginning of the value M[j]. That is, 0^{d1}∥M[j] may be employed.

The compression function f1[j] may be a function that extracts e2 bit from the input value. That is, in S25, the calculation value generation unit 131, where a value Z is e2 bit out of the value S1[i] and where a value Q1[1] is the value S1[i], in an ascending order starting with j=1 until the value Z has v bit or more, may adjoin to the value Z, e2 bit out of the value Q[j+1] obtained by substituting the value Q1[j] by a substitution function P1′[j].

In S27, the second input value generation unit 112 may generate the value E in the following manner.

The second input value generation unit 112 calculates, as a value K2, an exclusive OR of a key K and a k-bit fixed value opad. The second input value generation unit 112 adjoins a value N to the end of the value K2 to generate a value D. The second input value generation unit 112 adjoins a value Y to the end of the value D to generate an i′-times-e3-bit value E. That is, E=K2∥N∥Y.

A practical example of the value Y is a bit string in which the first bit and the last bit are 1 and the remaining bits are 0. That is, Y=1∥0 . . . 0∥1. The value Y is the shortest bit string with which the value E has multiple-of-e3-bit. When the value D has multiple-of-e3 bit, the value Y is a 0-bit bit string. The fixed value opad is a value different from the fixed value ipad.

Each function g2[j] may be a function that calculates an exclusive OR. That is, in S30, the second function calculation unit 122 may, for each integer j of j=1, in an ascending order, calculate R2[j]=S2[j−1] xor (N[j]∥0^{d3}) and S2[j]=P2[j](R[j]).

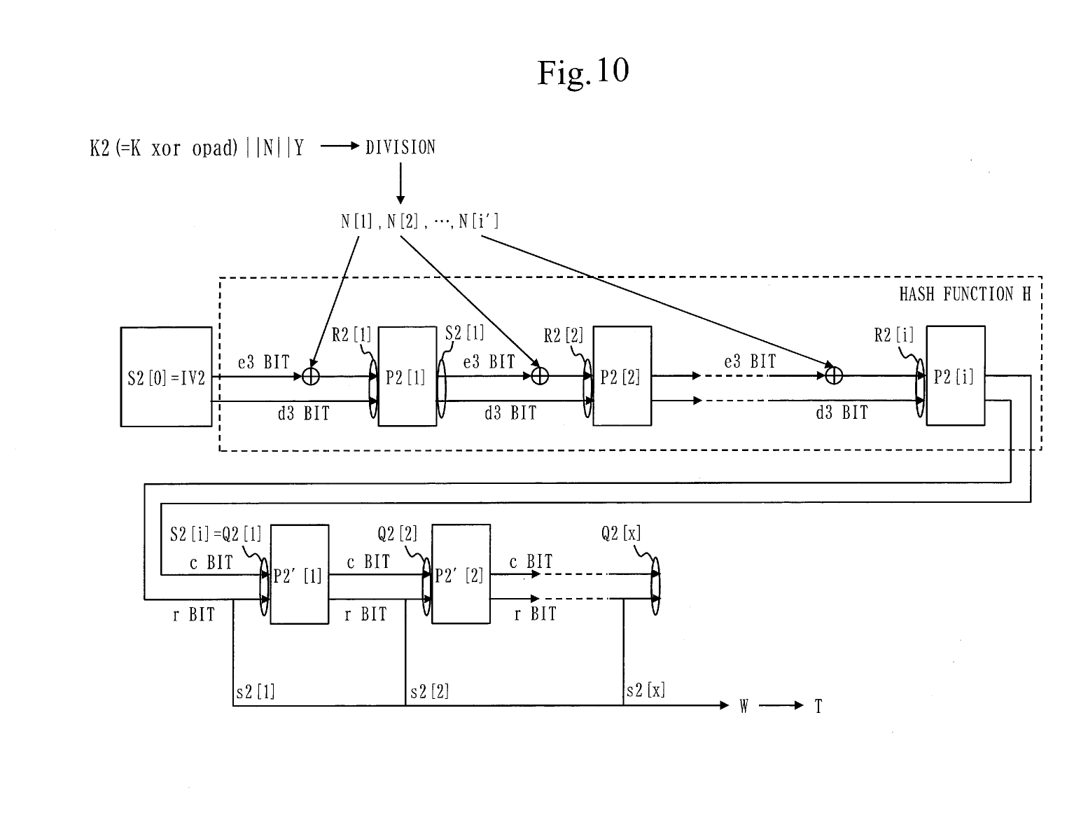

Calculation of the exclusive OR of an input value and 0 yields the input value as it is. Hence, as illustrated in FIG. 10, an exclusive OR of N[j] and e3 bit out of S2[j−1], and the remaining d3 bit out of S2[j−1] may form the value R[j]. That is, calculation of an exclusive OR of 0^{d3} and d3 bit out of S2[j−1] may be omitted.

Note that N[j]∥0^{d3} is employed. That is, d3-bit 0 is adjoined to the end of the value N[j]. However, the position where 0 is adjoined need not be the end of the value N[j]. More specifically, d3-bit 0 may be adjoined to the beginning of the value N[j]. That is, 0^{d3}∥N[j] may be employed.

The compression function f2[j] may be a function that extracts r bit from the input value. That is, in S31, the authenticator generation unit 132, where a value W is r bit out of the value S2[i] and where a value Q2[1] is the value S2[i], in an ascending order starting with j=1 until the value W has n bit or more, may adjoin to the value W, r bit out of the value Q2[j+1] obtained by substituting the value Q2[j] by a substitution function P2′[j].

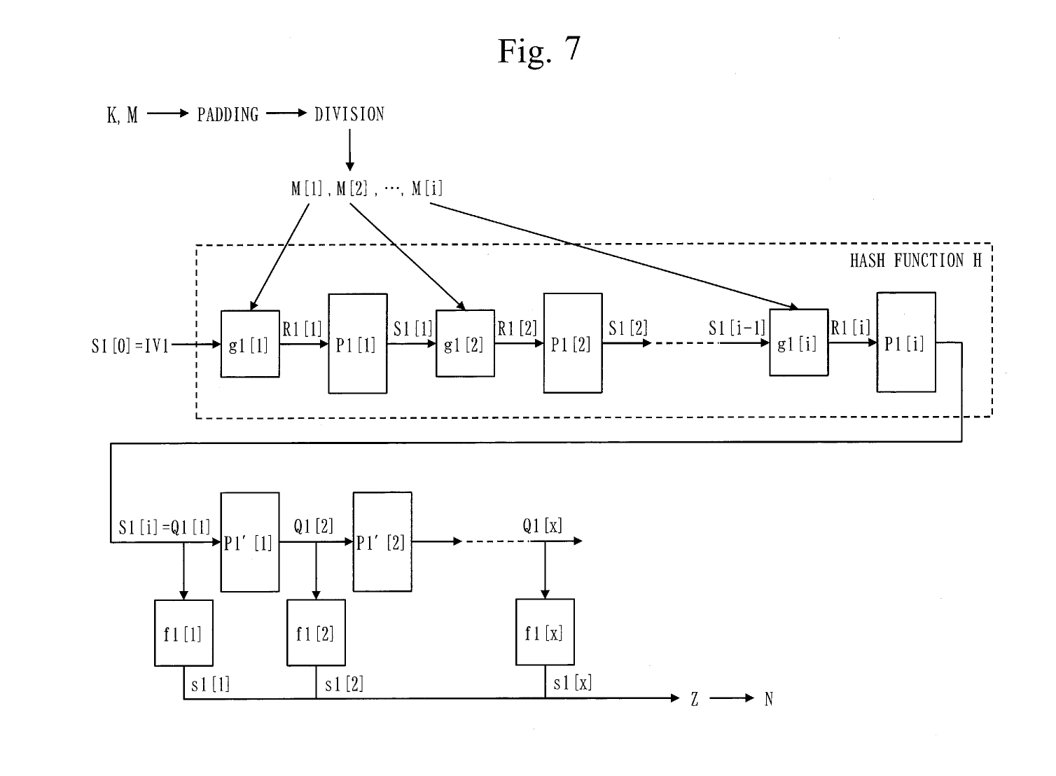

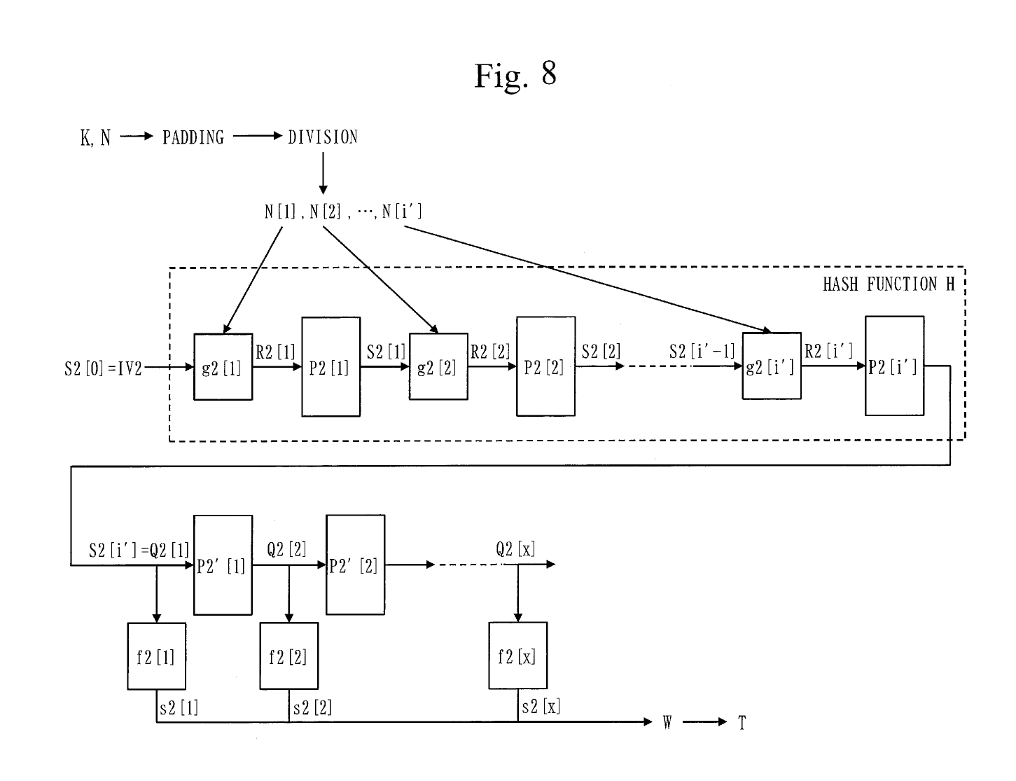

That is, the message authentication algorithms illustrated in FIGS. 7 and 8 may be configured as illustrated in FIGS. 9 and 10, respectively. In FIGS. 9 and 10, the calculation of the value C is C=K1∥M∥X. The calculation of the value R1[j] is R1[j]=S1[j−1] xor (M[j]0^{d1}) The compression function f1[j] is a function that extracts e2 bit from an input value. The calculation of the value E is E=K2∥N∥Y.

The calculation of the value R2[j] is R2[j]=S2[j−1] xor (N[j]∥0^{d3}). The compression function f2[j] is configured as a function that extracts r bit from an input value.

***Explanation of Hardware Configuration Example***

Finally, a hardware configuration example of the message authenticator generating apparatus 100 will be described.

The message authenticator generating apparatus 100 is a computer.

The function of the message authenticator generating apparatus 100 can be implemented by software or by hardware.

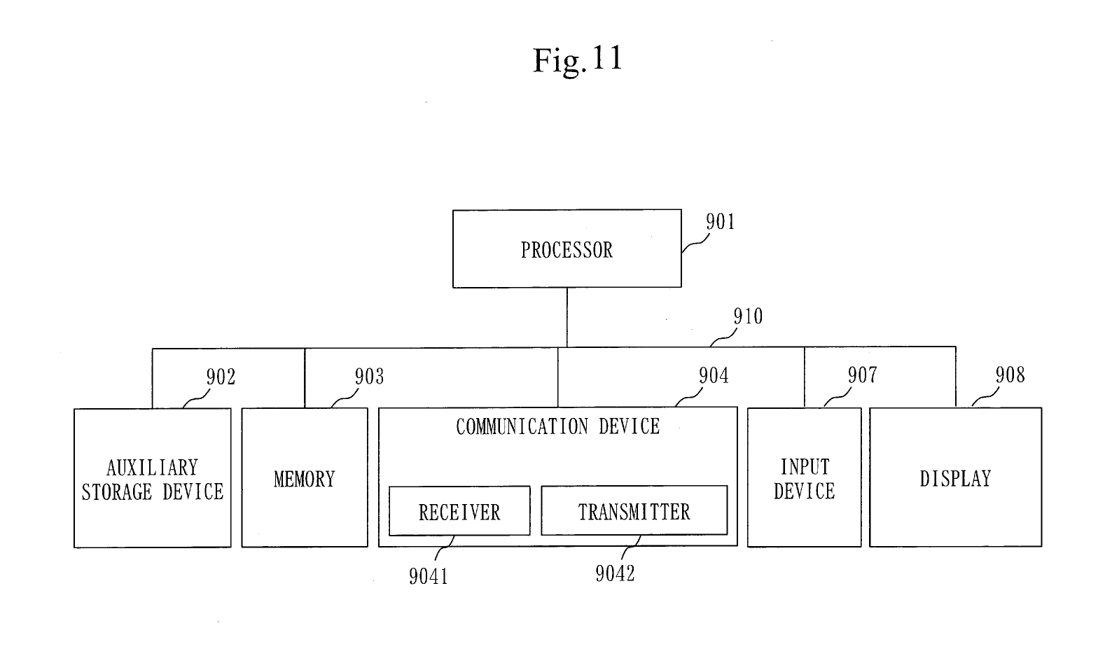

FIG. 11 illustrates a hardware configuration example of a case where the function of the message authenticator generating apparatus 100 is implemented by software.

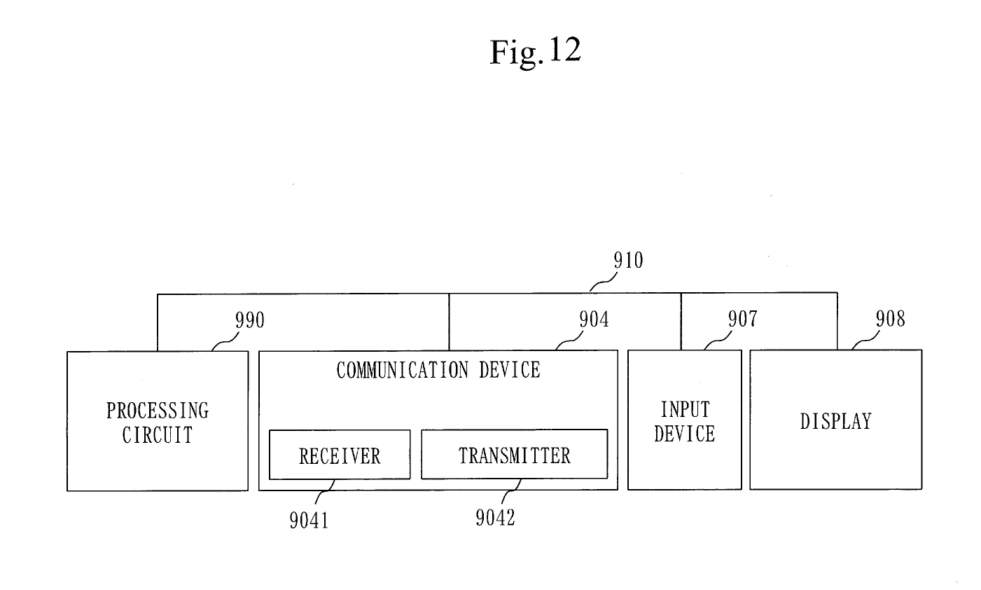

FIG. 12 illustrates a hardware configuration example of a case where the function of the message authenticator generating apparatus 100 is implemented by hardware.

A hardware configuration example of the message authenticator generating apparatus 100 will be described below with reference to FIGS. 11 and 12.

**Case Where Function of Message Authenticator Generating Apparatus 100 is Implemented by Software**

Where the function of the message authenticator generating apparatus 100 is implemented by software, the message authenticator generating apparatus 100 is provided with hardware devices such as a processor 901, an auxiliary storage device 902, a memory 903, a communication device 904, an input device 907, and a display 908, as illustrated in FIG. 11.

The processor 901 is connected to other hardware devices via a signal line 910 and controls the other hardware devices.

The processor 901 is an Integrated Circuit (IC) which performs processing. The processor 901 is specifically a Central Processing Unit (CPU), a Digital Signal Processor (DSP), or a Graphics Processing Unit (GPU).

The auxiliary storage device 902 is specifically a Read Only Memory (ROM), a flash memory, or a Hard Disk Drive (HDD).

The memory 903 is specifically a Random Access Memory (RAM).

The communication device 904 includes a receiver 9041 to receive data and a transmitter 9042 to transmit data. The communication device 904 is specifically a communication chip or a Network Interface Card (NIC).

The processor 901 is connected to the input device 907 via an input interface. The input interface is a port to which a cable of the input device 907 is connected. The processor 901 is also connected to the display 908 via a display interface. The display interface is a port to which a cable of the display 908 is connected.

The input device 907 is specifically a mouse, keyboard, or touch panel.

The display 908 is specifically a Liquid Crystal Display (LCD).

The auxiliary storage device 902 stores a program that implements the functions of the input value generation unit 110, function calculation unit 120, authenticator generation unit 130, first input value generation unit 111, second input value generation unit 112, first function calculation unit 121, second function calculation unit 122, calculation value generation unit 131, and authenticator generation unit 132. The input value generation unit 110, function calculation unit 120, authenticator generation unit 130, first input value generation unit 111, second input value generation unit 112, first function calculation unit 121, second function calculation unit 122, calculation value generation unit 131, and authenticator generation unit 132 will be collectively referred to as a “unit” hereinafter.

This program is loaded to the memory 903, read by the processor 901, and executed by the processor 901.

Furthermore, the auxiliary storage device 902 also stores an Operating System (OS). At least part of the OS is loaded to the memory 903. The processor 901, while executing the OS, executes the program that implements the function of the “unit”.

FIG. 11 illustrates a single processor 901. The message authenticator generating apparatus 100 may be provided with a plurality of processors 901. The plurality of processors 901 may cooperate with each other to execute the program that implements the function of the “unit”.

Information, data, signal values, and variable values indicating the results of the process of the “unit” are stored in the memory 903, the auxiliary storage device 902, or a register or cache memory in the processor 901. The program that implements the function of the “unit” may be stored in a portable storage medium such as a magnetic disk, a flexible disk, an optical disc, a compact disc, a Blu-ray (registered trademark) disc, or a DVD.

**Case Where Function of Message Authenticator Generating Apparatus 100 is Implemented by Hardware**

Where the function of the message authenticator generating apparatus 100 is implemented by hardware, the message authenticator generating apparatus 100 is provided with hardware devices such as a processing circuit 990, a communication device 904, an input device 907, and a display 908, as illustrated in FIG. 12.

The communication device 904, input device 907, display 908, and signal line 910 are equivalent to those described with reference to FIG. 11, and their description will accordingly be omitted.

The processing circuit 990 is a dedicated electronic circuit to implement the function of the “unit”. The processing circuit 990 is assumed to be a single circuit, a multiple circuit, a programmed processor, a parallel-programmed processor, a logic IC, a Gate Array (GA), an Application Specific Integrated Circuit (ASIC), or a Field-Programmable Gate Array (FPGA).

The function of the “unit” may be implemented by a single processing circuit 990, or may be implemented by a plurality of processing circuits 990 in a distributed manner.

**Case Where Function of Message Authenticator Generating Apparatus 100 is Implemented by Combination of Software and Hardware**

One or some functions of the message authenticator generating apparatus 100 may be implemented by dedicated hardware, and the other functions may be implemented by software (a program).

**Note**

The processor 901, the auxiliary storage device 902 and memory 903, and the processing circuit 990 are collectively referred to as “processing circuitry”.

That is, whether the hardware configuration of the message authenticator generating apparatus 100 may correspond to the hardware configuration of FIG. 11 or the hardware configuration of FIG. 12, the function of the “unit” is implemented by the processing circuitry.

The “unit” may be rephrased as “step”, a “procedure”, or a “process”.

The function of the “unit” may be implemented by firmware.

### Reference Signs List

100: message authenticator generating apparatus; 110: input value generation unit; 111: first input value generation unit; 112: second input value generation unit; 120: function calculation unit; 121: first function calculation unit; 122: second function calculation unit; 130: authenticator generation unit; 131: calculation value generation unit; 132: authenticator generation unit

1-8. (canceled)

9. A message authenticator generating apparatus comprising:
processing circuitry
to, taking as input a key K and a message M, generate an i-times-e-bit value E, and divide the value E at every e bit to generate values M[1], . . . , M[i], the value E being generated such that a value M[1] and a value M[i] out of the values M[1], . . . , M[i] include at least one of bits of the key K, to, where a value S[0] is a fixed value, for each integer j of j=1, i in an ascending order, calculate a value R[j] by a function g[j] taking as input a value S[j−1] and a value M[j] which is generated, and substitute the calculated value R[j] by a substitution function P[j] to calculate a value S[j], and
to generate an authenticator T for the message M with using a value S[i] calculated.

10. The message authenticator generating apparatus according to claim 9, wherein the processing circuitry, where a value Z is a value s[1] calculated by a compression function f[1] taking as input the value S[i], and where a value Q[1] is the value S[i], in an ascending order starting with j=1 until the value Z has n bit or more, adjoins to the value Z, a value s[j+1] calculated by a compression function f[j+1] taking as input a value Q[j+1] obtained by substituting the value Q[j] by a substitution function P′[j], and when the value Z has n bit or more, treats n bit out of the value Z as an authenticator T.

11. The message authenticator generating apparatus according to claim 9, wherein the processing circuitry adjoins the message M to an end of the key K to generate a value A, adjoins a value X to an end of the value A to generate a multiple-of-e-bit value C, adjoins the key K to an end of the value C to generate a value D, and adjoins a value Y to an end of the value D to generate the value E.

12. The message authenticator generating apparatus according to claim 9, wherein the function g[j] for each integer j of j=1, i is a function that calculates an exclusive OR.
